(19) United States
(12) Patent Application Publication
(10) Pub. No.: US 2026/0214507 A1
(43) Pub. Date: Jul. 23, 2026

(54) SYSTEM AND METHOD FOR DYNAMIC ENVIRONMENTAL CONGESTION DETECTION AND REMEDIATION FOR WIRELESS LINKS CAUSED BY INTERFERENCE BETWEEN ACTIVE UNIVERSAL SERIAL BUS PORTS

(71) Applicant: Dell Products LP, Round Rock, TX (US)

(72) Inventors: Jui-Chang Liu, New Taipei City (TW); Harpreet S. Narula, Austin, TX (US); Shao-Ku Huang, Da’an District (TW)

(73) Assignee: Dell Products LP, Round Rock, TX (US)

(21) Appl. No.: 19/031,746

(22) Filed: Jan. 18, 2025

(51) Int. Cl. H04W 28/02; G06F 13/38; G06F 13/42

(52) U.S. Cl. CPC H04W 28/0289; G06F 13/382; G06F 13/4282; G06F 2213/0042

(57) ABSTRACT

A wireless peripheral device dongle executing a wireless link dynamic environmental congestion detection and remediation system may comprise a wireless peripheral device dongle radio to establish a wireless link between the wireless peripheral device dongle operatively coupled to an information handling system, via a first universal serial bus (USB) port, and a wireless peripheral input/output device at a default physical layer data and transfer rate. A hardware controller executes to determine that a number of data packets dropped on the wireless link meets a threshold congestion value within a testing time period due to interference from a second USB port of the information handling system, and the hardware controller to decrease a physical layer data and transfer rate for the wireless link to a congestion-avoidance physical layer data and transfer rate value for decreasing wireless congestion or further decreasing a physical radio transfer rate for the wireless link for congestion avoidance.

### FIELD OF THE DISCLOSURE

The present disclosure generally relates to wireless peripheral device dongles and other devices that operatively couple with information handling systems via Universal Serial Bus (USB) connectors for wireless communication with a wireless peripheral IO device. The present disclosure more specifically relates to executing machine readable code instructions of a system and method for dynamic environmental congestion detection and remediation for wireless links caused by interference between multiple USB ports occupied by dongles or other devices at an information handling system by throttling data and transfer rate and data symbol transfer rate for an established wireless link undergoing detected threshold congestion.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may further include plural ports, such as Universal Serial Bus (USB) ports, for connection of one or more wired peripheral devices or dongles for wireless connectivity.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to one or more wireless peripheral device dongles or a wired peripheral device via a plurality of Universal Serial Bus (USB) ports according to an embodiment of the present disclosure;

FIG. 2 is a graphic diagram illustrating USB ports operatively connecting an information handling system to a wireless peripheral device dongle and a wired peripheral device creating interference on a wireless link between the wireless peripheral device dongle and a wirelessly coupled wireless peripheral input/output (IO) device according to an embodiment of the present disclosure;

FIG. 3 is a graphical diagram illustrating USB ports operatively connecting an information handling system to a first wireless peripheral device dongle and a second wireless peripheral device dongle creating interference on a wireless link between the first wireless peripheral device dongle and a first wireless peripheral IO device wirelessly coupled with the first wireless peripheral device dongle according to an embodiment of the present disclosure;

FIG. 4 is a graphical diagram illustrating a wireless link dynamic environmental congestion detection and remediation system or agent thereof operating on a wireless peripheral device dongle or a wireless peripheral IO device controller according to an embodiment of the present disclosure; and

FIG. 5 is a flow diagram illustrating a method of a wireless peripheral device dongle or a wireless peripheral IO device dynamically detecting and remediating congestion due to interference on a wireless link between the wireless peripheral device dongle and the wireless peripheral IO device according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Users of information handling systems often employ multiple input/output (IO) devices, each communicating with an information handling system, such as a desktop or laptop computer simultaneously via Universal Serial Bus (USB) ports on the information handling system. In many cases, at least one of these USB ports is operatively coupled to a wireless peripheral device dongle that can communicate wirelessly with a wireless peripheral IO device, such as a mouse, headphones, keyboard, or other wireless IO device. Such USB ports (e.g., USB 2.0 or USB 3.0 standardized ports) are often times located near each other, often on the same exterior wall of the chassis for the information handling system, which can cause interference, such as cross-talk, between these USB ports when occupied by wired or wireless devices in such proximity. This interference between the USB ports can cause any wireless link established between an operatively coupled wireless peripheral device dongle and a wireless peripheral IO device to undergo wireless congestion causing lost data packets to be dropped with a high frequency and potentially retries slowing the data traffic. This may cause lag or lost data in the form of lagged cursor movement with a mouse, unrecognized mouse clicks or key presses, or interrupted audio signals for wireless audio devices, for example. A system is needed to detect and remediate any environmental congestion on wireless links between such a wireless peripheral device dongle operatively coupled to the information handling system via a USB port and a wireless peripheral IO device caused by either another wired peripheral IO device or a secondary wireless peripheral device dongle operatively coupled to a nearby secondary USB port in order to avoid a negative user experience.

The wireless link established between such a wireless peripheral device dongle operatively coupled to the information handling system and a wireless peripheral IO device may initially be established at a default data and transfer rate supportable by the wireless peripheral IO device. For example, in the case of a wireless peripheral IO device operating in compliance with the Bluetooth® (BT) or Bluetooth® Low Energy (BTLE) communication protocols, the wireless peripheral IO device may be capable of operating at a default data and transfer rate of two megabits per second (2 Mbps) which may be set as the default data and transfer rate under the protocol. Congestion on a wireless link caused by close proximity between multiple USB ports of the information handling system generating cross-talk or other interferences at the USB ports operatively coupling with a first wireless peripheral device dongle and either a wired peripheral IO device or a second wireless peripheral device dongle may be avoided or addressed in embodiments herein through a plurality of remediation measures that throttle down the data and transfer rate or throttle down the data symbol transfer rate of the established wireless link between the wireless peripheral device dongle and the wireless peripheral IO device. The data and transfer rate in embodiments herein may refer to the maximum data size (e.g., in megabits (Mb)) allowed to transfer within one second through the established wireless link between the wireless peripheral device dongle and the wireless peripheral IO device. The physical radio transfer rate in embodiments herein may refer to the actual electrical physical signal transfer rate of each data packet being transferred per second across the wireless link, such as number or packets or symbols packaged into or with the PHY data and transfer rate being transferred per second, as given in Hertz (Hz) wirelessly. By reducing the data and transfer rates in physical layer (PHY) data and transfer rate as a first measure and then lowering a link layer physical radio transfer rate, the data transmitted wirelessly across the wireless link with the first wireless peripheral device dongle may suffer from less user interruption by any lost data packets and avoid retries during congestion due to USB port interference of the active, occupied USP ports. Although reducing the data and transfer rates in physical layer (PHY) data and transfer rate as a first measure and then lowering a link layer physical radio transfer rates may reduce data resolution somewhat, the overall performance of wireless data throughput during congestion is improved over otherwise lost packets and induced lag in performance.

A wireless link dynamic environmental congestion detection and remediation system in embodiments of the present disclosure may detect wireless congestion on a wireless link between the wireless peripheral device dongle and the wireless peripheral IO device and take one or more steps to remediate such congestion by throttling the PHY data and transfer rate or the link layer transmit symbol data symbol transfer rate of such a wireless link. The wireless link dynamic environmental congestion detection and remediation system or an agent thereof may operate in various embodiments herein either on a wireless peripheral device dongle or on the wireless peripheral IO device sharing the wireless link with such a wireless peripheral device dongle. A hardware microcontroller for the wireless peripheral device dongle or a hardware controller for the wireless peripheral IO device in embodiments herein may execute machine readable code instructions of the wireless link dynamic environmental congestion detection and remediation system or agent, respectively, to monitor a wireless physical radio transfer rate and an error rate for dropped packets on the wireless link between the wireless peripheral device dongle and the wireless peripheral IO device. Upon detection of a number of dropped packets within a preset period of time that meets a threshold congestion value, such as ten percent of packets transmitted within any three second time period being dropped, for example, one or more remediation measures to reduce the wireless link threshold congestion may be triggered. Although embodiments herein refer to hardware microcontroller for the wireless peripheral device dongle, such as a protocol baseband microcontroller unit, or a hardware controller for the wireless peripheral IO device, such as a mouse hardware controller in embodiments herein, any hardware processing resource is contemplate to execute machine readable code instructions of the wireless link dynamic environmental congestion detection and remediation system or agent, respectively, at either wireless peripheral device dongle or the wireless peripheral IO device in various embodiments herein. Thus, an hardware controller or other processing resource, including a microcontroller, may operate at the wireless peripheral device dongle in embodiments herein. Similarly, a microcontroller or other processing resource, including a hardware controller, may operate at the wireless peripheral IO device.

In embodiments herein, the microcontroller for the wireless peripheral device dongle the hardware controller for the wireless peripheral IO device may execute machine readable code instructions of a wireless link dynamic environmental congestion detection and remediation system or agent to determine whether the wireless link is currently set to a highest available data and transfer rate supported by the wireless peripheral IO device. In some embodiments, the hardware controller for the wireless peripheral IO device may be a microcontroller integrated circuit chip, an applied specific integrated circuit (ASIC), or other hardware controller chip onboard a printed circuit board of the wireless peripheral IO device. Similarly, a microcontroller of the wireless peripheral device dongle may be any microcontroller, ASIC, or hardware controller integrated circuit onboard a printed circuit board of the wireless peripheral device dongle.

If the wireless link is currently set to a highest available data and transfer rate supported by the wireless peripheral IO device, the microcontroller for the wireless peripheral device dongle or the hardware controller for the wireless peripheral IO device may execute machine readable code instructions of the wireless link dynamic environmental congestion detection and remediation system or agent, respectively, to decrease a data and transfer rate via one or more remediation measures to a congestion-avoidance data and transfer rate value for the wireless link undergoing threshold congestion. For example, if the wireless link is operating at a BT or BTLE maximum available data and transfer rate of two Mbps, the microcontroller for the wireless peripheral device dongle or the hardware controller for the wireless peripheral IO device may execute machine readable code instructions of the wireless link dynamic environmental congestion detection and remediation system or agent, respectively, to decrease the physical layer (PHY) data and transfer rate for the wireless link to a congestion-avoidance data and transfer rate value of one Mbps.

If the wireless link is not currently set to a highest available data and transfer rate supported by the wireless peripheral IO device, this may indicate that some remediation has already been attempted to decrease or avoid detected wireless congestion. In other words, the data and transfer rate for the wireless link undergoing threshold congestion may have already been throttled to the lower congestion-avoidance data and transfer rate value. In such a case, the microcontroller for the wireless peripheral device dongle or the hardware controller for the wireless peripheral IO device may execute machine readable code instructions of the wireless link dynamic environmental congestion detection and remediation system or agent, respectively, to decrease a data physical radio transfer rate to a congestion-avoidance physical radio transfer rate value for the wireless link undergoing threshold congestion to reduce data lost. For example, the microcontroller for the wireless peripheral device dongle or the hardware controller for the wireless peripheral IO device may execute machine readable code instructions of the wireless link dynamic environmental congestion detection and remediation system or agent, respectively, to decrease a link layer data symbol transmit rate from a maximum of 125 Hz to a congestion-avoidance physical radio transfer rate value or 105 Hz.

When one or more remediation steps have been executed to avoid or decrease wireless congestion on the wireless link between the wireless peripheral device dongle and the wireless peripheral IO device, the microcontroller for the wireless peripheral device dongle or the hardware controller for the wireless peripheral IO device may execute machine readable code instructions of a wireless link dynamic environmental congestion detection and remediation system or agent, respectively, to determine whether the one or more remediation steps previously executed have decreased the wireless congestion on the wireless link between the wireless peripheral device dongle and the wireless peripheral IO device. Further, the wireless congestion may be monitored as before, and if congestion has alleviated, the wireless link dynamic environmental congestion detection and remediation system or agent may release back to the default higher PHY data and transfer rate and transmit data symbol rates in embodiments herein. This process may be repeated periodically in order to dynamically ensure that the wireless link between the wireless peripheral device dongle and the wireless peripheral IO device balances the data and transfer rate and physical radio transfer rate to minimize wireless congestion and maximize user experience.

In order to maximize user experience in such a way, the microcontroller for the wireless peripheral device dongle or the hardware controller for the wireless peripheral IO device may execute machine readable code instructions to return the wireless link to its original highest available data and transfer rate when monitored congestion, determined from data packet loss threshold, is not detected. In other words, when threshold congestion is not detected on the wireless link between the wireless peripheral device dongle and the wireless peripheral IO device, the microcontroller for the wireless peripheral device dongle or the hardware controller for the wireless peripheral IO device may execute machine readable code instructions of a wireless link dynamic environmental congestion detection and remediation system or agent, respectively, to place the wireless link for the operatively coupled wireless peripheral IO device at a default data and transfer rate supportable by the wireless peripheral IO device and remove any limitations set on the data symbol transmit rate for that wireless link that may have been established during previous remediation steps. In such a way, the microcontroller for the wireless peripheral device dongle or the hardware controller for the wireless peripheral IO device may execute machine readable code instructions of a wireless link dynamic environmental congestion detection and remediation system or agent, respectively, to dynamically ensure that the wireless link between the wireless peripheral device dongle and the wireless peripheral IO device balances the data and transfer rate and physical radio transfer rate to minimize wireless congestion and maximize user experience.

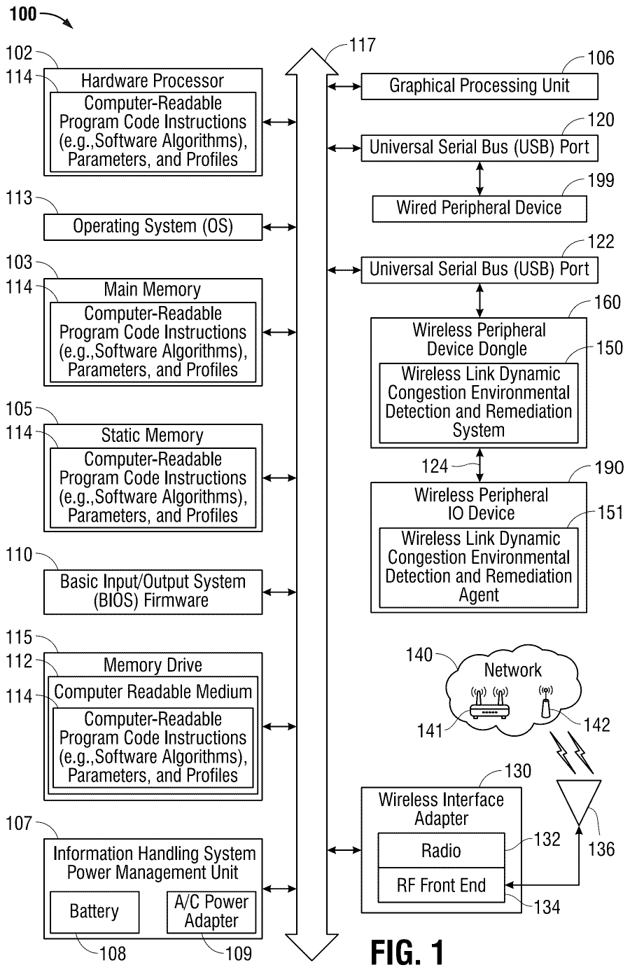

Turning now to the figures, FIG. 1 illustrates an information handling system 100 similar to the information handling systems according to several aspects of the present disclosure. As described herein, a user of information handling system 100 may employ multiple input/output devices, such as wired peripheral device 199 or wireless peripheral IO device 190, each active in communicating with the information handling system 100, such as a desktop or laptop computer, simultaneously via Universal Serial Bus (USB) ports 120 and 122, respectively on the information handling system 100. In many cases, at least one of these USB ports, such as 122, is operatively coupled to a wireless peripheral device dongle 160 that can communicate wirelessly with a wireless peripheral IO device 190, such as a mouse, headphones, keyboard, or other wireless IO device. Such USB ports 120 and 122 (e.g., USB 2.0 or USB 3.0 standardized ports) are often times located nearby each other in close proximity, often on the same exterior wall of the chassis for the information handling system 100, which can cause interference between the wired communication lines of these USB ports 120 and 122, separate and apart from any type of environmental radio interference.

This interference between the USB ports 120 and 122 can cause any wireless link, such as wireless link 124, established between an operatively coupled wireless peripheral device dongle 160 and a wireless peripheral IO device 190 to undergo wireless congestion in which data packets are dropped with a high frequency. This may cause lag or lost data in the form of lag in cursor movement, unrecognized mouse clicks or key presses, or interrupted audio signals, for example. The wireless link 124 established between such a wireless peripheral device dongle 160 operatively coupled to the information handling system 100 via USB port 122 and a wireless peripheral IO device 160 may initially be established at a default data and transfer rate supportable by the wireless peripheral IO device 190. For example, in the case of a wireless peripheral IO device 190 operating in compliance with the Bluetooth® (BT) or Bluetooth® Low Energy (BTLE) communication protocols, the wireless peripheral IO device 190 may be capable of operating at, and thus may operate by default at a default data and transfer rate of two megabits per second (2 Mbps). Congestion on the wireless link 124 caused by close proximity between multiple USB ports 122 and 120 of the information handling system 100 operatively coupling and active with a first wireless peripheral device dongle 160 and either a wired peripheral IO device 199 or a second wireless peripheral device dongle (not shown), respectively, may be avoided or addressed in embodiments herein through a plurality of remediation measures that throttle down the physical layer (PHY) data and transfer rate or throttle down the data symbol transfer rate of a link layer of the established wireless link 124 between the wireless peripheral device dongle 160 and the wireless peripheral IO device 190. The data and transfer rate in embodiments herein may refer to the maximum data size (e.g., in megabits (Mb)) allowed to transfer within one second through the established wireless link 124 between the wireless peripheral device dongle 160 and the wireless peripheral IO device 190 as in the physical layer (PHY) of the Bluetooth® or Wi-Fi protocols. The physical radio transfer rate in embodiments herein may refer to the actual electrical physical signal transfer rate of each data packet being transferred per second across the wireless, such as number or packets or symbols packaged into or with the PHY data and transfer rate being transferred per second, as given in Hertz (Hz) on wireless link 124.

Machine readable code instructions of a wireless link dynamic environmental congestion detection and remediation system 150 executing at the wireless peripheral device dongle 160, or machine readable code instructions of a wireless link dynamic environmental congestion detection and remediation agent 151 operating at the wireless peripheral IO device 190 in an embodiment may detect wireless congestion on a wireless link between the wireless peripheral device dongle and the wireless peripheral IO device and take one or more steps to remediate such congestion by throttling the data and transfer rate or the data symbol transfer rate of such a wireless link 124, as described in greater detail in embodiments herein. The wireless link dynamic environmental congestion detection and remediation system 150 or an agent thereof 151 may operate in various embodiments herein on a wireless peripheral device dongle 160, on the wireless peripheral IO device 190, or partially on both sharing the wireless link 124.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 115. The information handling system 100 may include or interface with one or more communications ports 120 or 122 for communicating with external devices, as well as an input/output (IO) device 190 or 199, a video/graphics digital display device 120, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various wireless or wired I/O devices 190 or 199, as well as between hardware processors 102, an EC 104, GPU 106 or other, the operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the wireless or wired input/output devices 190 or 199 described herein. Wired or wireless input/output devices 190 and 199 may include any type of IO device, such as a microphone, camera, digital display device, battery, mouse, keyboard, headset, or thumb drive, for example.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104, or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows®, Android®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114 in which one or more sets of machine-readable code instructions, parameters, and profiles 114, such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, EC 104, GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114, such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the EC 104, the GPU 106, USB port 120 or 122, the wireless peripheral device dongle 160, or other wired I/O devices 199 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

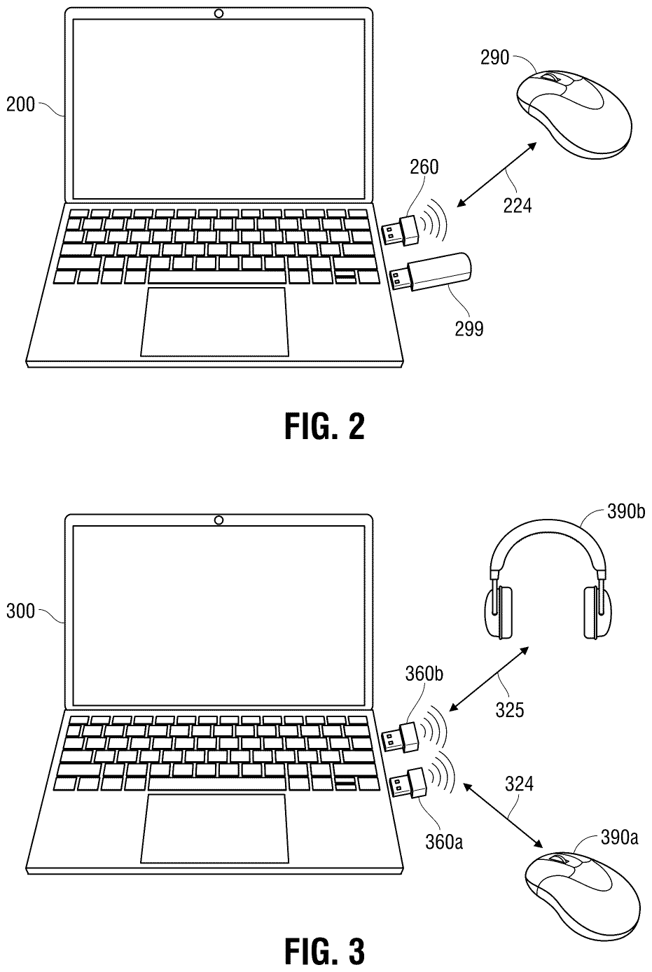

FIG. 2 is a block diagram illustrating Universal Serial Bus (USB) ports operatively connecting an information handling system to a wireless peripheral device dongle and a wired peripheral device creating interference on a wireless link between the wireless peripheral device dongle and a wireless peripheral IO device according to an embodiment of the present disclosure. As described herein, a user of information handling system 200 may employ multiple input/output devices, such as a wireless peripheral device dongle 260 in wireless communication with a wireless peripheral IO device 290. Wireless peripheral IO device 290 may be a wireless mouse, wireless headphones, wireless keyboard, or other wireless IO device. Further, user of information handling system 200 may employ a wired peripheral device 299. The wired peripheral IO device 299 in such an embodiment may include, for example, a mouse, headphones, keyboard, an external memory device such as a thumb drive, or other wired IO device. Each of the wireless peripheral device dongle 290 and the wired peripheral device 299 in an embodiment may be operatively coupled and actively operating with an information handling system 200, such as a desktop or laptop computer, simultaneously via Universal Serial Bus (USB) ports on the information handling system 200. Such USB ports (e.g., USB 2.0 or USB 3.0 standardized ports) are often times located near each other, often on the same exterior wall of the chassis for the information handling system 200. When active, these USB ports with the wireless peripheral device dongle 290 and the wired peripheral device 299 can cause interference, such as cross-talk interference, between these USB ports that may impact the wireless link 224 apart or in addition to environmental radiofrequency interference. This interference between the USB ports can cause any wireless link 242 established between an operatively coupled wireless peripheral device dongle 260 and a wireless peripheral IO device 290 to undergo wireless congestion in which data packets are dropped with a high frequency and successful data packet throughput is reduced. This may cause lag or lost data in the form of laggy cursor movement, unrecognized mouse clicks or key presses, or interrupted audio signals, for example.

FIG. 3 is a graphical diagram illustrating Universal Serial Bus (USB) ports operatively connecting an information handling system to a first wireless peripheral device dongle and a second wireless peripheral device dongle creating interference on a wireless link between the first wireless peripheral device dongle and a first wireless peripheral IO device according to an embodiment of the present disclosure. In an example embodiment, users of the information handling system 300 may employ multiple input/output devices 360a and 360b, such as a first wireless peripheral device dongle 360a in wireless communication with a wireless peripheral IO device 390a, and a second wireless peripheral device dongle 360b in wireless communication with a second wireless peripheral IO device 390b. The first and second wireless peripheral IO devices 390a and 390b, respectively, in such embodiments may include, for example, a wireless mouse, wireless headphones, wireless keyboard, or other wireless IO device. Each of the first and second wireless peripheral device dongles 360a and 360b in an embodiment may be operatively coupled with an information handling system 300 simultaneously via Universal Serial Bus (USB) ports on the information handling system 300. As described herein, such USB ports (e.g., USB 2.0 or USB 3.0 standardized ports) are often times located near each other, often on the same exterior wall of the chassis for the information handling system 300, which can cause interference between these USB ports. With IO devices active and coupled to the USB ports, this interference between the USB ports, such as cross-talk interference, can cause any wireless link 324 or 325 established between an operatively coupled wireless peripheral device dongle 360a or 360b and a wireless peripheral IO device 390a or 390b to undergo wireless congestion in which data packets are dropped with a high frequency. This causes a reduction in successful wireless data throughput apart from interference caused by environmental radiofrequency interference. Such congestion may cause lag or lost data in the form of laggy cursor movement, unrecognized mouse clicks or key presses, or interrupted audio signals, for example.

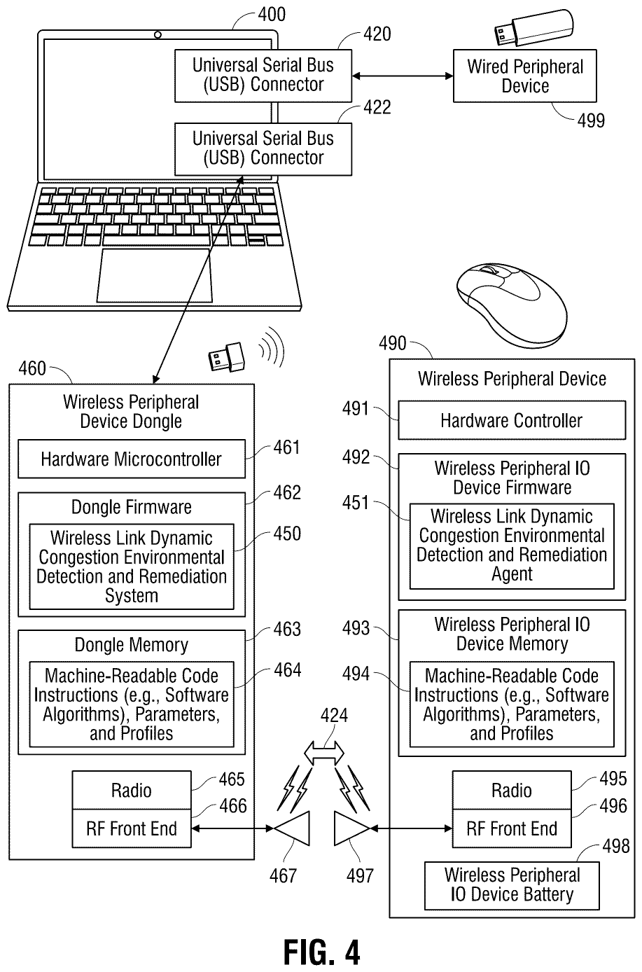

FIG. 4 is a graphical diagram illustrating a wireless link dynamic environmental congestion detection and remediation system or agent thereof operating on a wireless peripheral device dongle or a wireless peripheral input/output (IO) device controller to dynamically detect and remediate congestion due to plural Universal Serial Bus (USB) ports on a wireless link operatively coupling the wireless peripheral device dongle with the wireless peripheral IO device according to an embodiment of the present disclosure. As described herein, a user of information handling system 400 may employ multiple input/output devices, such as wired peripheral device 499 or wireless peripheral IO device 490, each communicating with the information handling system 400, such as a desktop or laptop computer simultaneously via USB ports 420 and 422, respectively on the information handling system 400. In many cases, at least one of these USB ports, such as 422, is operatively coupled to a wireless peripheral device dongle 460 that can communicate wirelessly with a wireless peripheral IO device 490, such as a wireless mouse, wireless headphones, wireless keyboard, or other wireless IO device. Such USB ports 420 and 422 (e.g., USB 2.0 or USB 3.0 standardized ports) are often times located nearby each other in close proximity, often on the same exterior wall of the chassis for the information handling system 400, which can cause interference, such as cross-talk interference, between the wired communication lines of these USB ports 420 and 422, separate and apart from any type of radio interference.

This interference between the USB ports 420 and 422 can cause any wireless link, such as wireless link 424, established between an operatively coupled wireless peripheral device dongle 460 and a wireless peripheral IO device 490 to undergo wireless congestion in which data packets are dropped. When this level of data packet loss and resulting congestion reaches a high enough frequency, this may cause lag or lost data in the form of laggy cursor movement, unrecognized mouse clicks or key presses, or interrupted audio signals, for example. The wireless link 424 established between such a wireless peripheral device dongle 460 operatively coupled to the information handling system 400 via USB port 422 and a wireless peripheral IO device 460 may initially be established at a default data and transfer rate supportable by the wireless peripheral IO device 490 and the wireless protocol used for the wireless link 424. For example, in the case of a wireless peripheral IO device 490 operating in compliance with the Bluetooth® (BT) or Bluetooth® Low Energy (BTLE) communication protocols, the wireless peripheral IO device 490 may be capable of operating at, and thus may operate by default at, a default data and transfer rate of two megabits per second (2 Mbps). Congestion on the wireless link 424 caused by close proximity between multiple USB ports 422 and 420 of the information handling system 400 operatively coupling with a first wireless peripheral device dongle 460 and either a wired peripheral IO device 499 or a second wireless peripheral device dongle, respectively, may be avoided or addressed in embodiments herein through a plurality of remediation measures that throttle down the PHY data and transfer rate or throttle down the physical radio transfer rate of the established wireless link 424 between the wireless peripheral device dongle 460 and the wireless peripheral IO device 490 when a threshold congestion value, based on missed data packets or identified failed acknowledgment (ACK) responses to wireless data packet transfers is reached.

A wireless link dynamic environmental congestion detection and remediation system 450 operating at the wireless peripheral device dongle 460, or a wireless link dynamic environmental congestion detection and remediation agent 451 operating at the wireless peripheral IO device 490 in an embodiment may detect wireless congestion on a wireless link between the wireless peripheral device dongle and the wireless peripheral IO device and take one or more steps to remediate such congestion by throttling the data and transfer rate or the data symbol transfer rate of such a wireless link 424. The wireless link dynamic environmental congestion detection and remediation system 450 or an agent thereof 451 may operate in various embodiments herein either on a wireless peripheral device dongle 460, on the wireless peripheral IO device 490 sharing the wireless link 424 with such a wireless peripheral device dongle 460, or on some combination to execute operations of detecting congestion thresholds and executing one or more of the remediation measures by the wireless link dynamic environmental congestion detection and remediation system 450 or agent 451.

The wireless peripheral device dongle 460 may include a hardware microcontroller 461 for executing firmware 462 or machine-readable code instructions 464, such as machine readable code instructions for the wireless link dynamic environmental congestion detection and remediation system 450, as stored within a wireless peripheral device dongle memory 463. In an embodiment, the wireless peripheral device dongle 460 may include the hardware microcontroller 461 such as a protocol baseband controller such as a BT microcontroller unit, or other hardware processing resources on the wireless peripheral device dongle 460. Any of the hardware processing resources may operate to execute machine readable code instructions 464 that are either firmware 462 or software code, such as machine readable code instructions for the wireless link dynamic environmental congestion detection and remediation system 450. The wireless peripheral device dongle 460 may include a set of instructions 464 that may be executed to cause the computer system to perform any one or more of the methods or computer-based functions disclosed herein. For example, machine readable code instructions 464 may be executed by a hardware microcontroller 461 or any other hardware processing resource and may include software agents, or other aspects or components used to execute the methods and systems described herein.

Moreover, the wireless peripheral device dongle 460 may include memory 463, such as volatile (e.g., random-access memory, etc.), nonvolatile memory (read-only memory, flash memory etc.) or any combination thereof or other memory with computer readable medium storing machine readable code instructions (e.g., software or firmware algorithms), parameters, and profiles 464 executable by the hardware microcontroller 461 or any other hardware processing device to perform the processes described herein. Memory 463 or other memory of the embodiments described herein may contain computer-readable medium (not shown), such as RAM in an example embodiment. An example of memory 463 includes random access memory (RAM) such as static RAM (SRAM), dynamic RAM (DRAM), non-volatile RAM (NV-RAM), or the like, read only memory (ROM), another type of memory, or a combination thereof. In another aspect of an embodiment, memory 463 may contain computer-readable medium (not shown), such as NOR or NAND flash memory in some example embodiments.

In an embodiment, the wireless peripheral device dongle 460 may further include a radio 465 and a radio frequency (RF) front end 466. In embodiments described herein, the wireless peripheral device dongle 460 with its radio 465, RF front end 466 and antenna 467 is used to communicate with the wireless peripheral IO device 490, via, for example, a Bluetooth® or Bluetooth® Low Energy (BLE) protocols, or other WPAN or WLAN protocols. Wireless peripheral device dongle 460 may include one or more radio frequency (RF) subsystems (e.g., radio 465) with transmitter/receiver circuitry, modem circuitry, one or more antenna RF front end circuits 466, one or more wireless controller circuits, amplifiers, antennas 467 and other circuitry of the radio 465 such as one or more antenna ports used for wireless communications via multiple radio access technologies (RATs). The radio 465 may communicate with one or more wireless technology protocols.

The wireless peripheral device dongle 460 in an embodiment may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless peripheral device dongle 460 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums.

As described herein, the wireless link dynamic environmental congestion detection and remediation system 450 or an agent thereof 451 may operate in various embodiments herein either on a wireless peripheral device dongle 460 or on the wireless peripheral IO device 490 sharing the wireless link 424 with such a wireless peripheral device dongle 460. The wireless peripheral IO device 490 may include a hardware controller 491 for executing firmware 492 or machine-readable code instructions 494, such as machine readable code instructions for the wireless link dynamic environmental congestion detection and remediation agent 451, as stored within a wireless peripheral IO device memory 493. In an embodiment, the wireless peripheral IO device 490 may include the hardware controller 491 such as one or more scaler controllers, or other hardware processing resources. Any of the hardware processing resources may operate to execute machine readable code instructions 494 that are either firmware 492 or software code, such as machine readable code instructions for the wireless link dynamic environmental congestion detection and remediation agent 451. The wireless peripheral IO device 490 may include a set of instructions 494 that may be executed to cause the computer system to perform any one or more of the methods or computer-based functions disclosed herein. For example, machine readable code instructions 494 may be executed by a hardware controller 491 or any other hardware processing resource and may include software agents, or other aspects or components used to execute the methods and systems described herein. In an embodiment, the wireless peripheral IO device 490 may further include a battery 498. The battery 498 may control power to one or more components including the hardware controller 491, radio 495, RF front end 496, antenna 497, and other components that may require power when a power button has been actuated by a user.

Moreover, the wireless peripheral IO device 490 may include memory 493, such as volatile (e.g., random-access memory, etc.), nonvolatile memory (read-only memory, flash memory etc.) or any combination thereof or other memory with computer readable medium storing machine readable code instructions (e.g., software or firmware algorithms), parameters, and profiles 494 executable by the hardware controller 491 or any other hardware processing device to perform the processes described herein. Memory 493 or other memory of the embodiments described herein may contain computer-readable medium (not shown), such as RAM in an example embodiment. An example of memory 493 includes random access memory (RAM) such as static RAM (SRAM), dynamic RAM (DRAM), non-volatile RAM (NV-RAM), or the like, read only memory (ROM), another type of memory, or a combination thereof. In another aspect of an embodiment, memory 493 may contain computer-readable medium (not shown), such as NOR or NAND flash memory in some example embodiments.

In an embodiment, the wireless peripheral IO device 490 may further include a radio 495 and a radio frequency (RF) front end 496. In embodiments described herein, the wireless peripheral IO device 490 with its radio 495, RF front end 496 and antenna 497 is used to communicate with the wireless peripheral device dongle 460, via, for example, a Bluetooth® or Bluetooth® Low Energy (BLE) protocols, or other WPAN or WLAN protocols. Wireless peripheral IO device 490 may include one or more radio frequency (RF) subsystems (e.g., radio 495) with transmitter/receiver circuitry, modem circuitry, one or more antenna RF front end circuits 496, one or more wireless controller circuits, amplifiers, antennas 497 and other circuitry of the radio 495 such as one or more antenna ports used for wireless communications via multiple radio access technologies (RATs). The radio 495 may communicate with one or more wireless technology protocols.

The wireless peripheral IO device 490 in an embodiment may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. The wireless peripheral IO device 490 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums.

A hardware microcontroller 461 for the wireless peripheral device dongle 460 or a microcontroller 491 for the wireless peripheral IO device 491 in an embodiment may execute machine readable code instructions 464 or 494, respectively of the wireless link dynamic environmental congestion detection and remediation system 450 or agent 451, respectively, to monitor an error rate for dropped packets on the wireless link 424 between the wireless peripheral device dongle 460 and the wireless peripheral IO device 490. For example, hardware microcontroller 461 or other hardware controller for the wireless peripheral device dongle 460, such as a baseband BT microcontroller unit, executes machine readable code instructions of the wireless link dynamic environmental congestion detection and remediation system 450 to detect packet error rate in transmission of wireless data at radio 465 and radiofrequency (RF) front end 466 within a threshold congestion testing time period on the first wireless link in an embodiment. Such a packet error rate may be determined by retries required or failed data transmission experienced at the radio 465 and RF front end 466 and detected by the hardware microcontroller 461 within a congestion testing time period on the first wireless link. In another embodiment, a hardware controller 491 for the wireless peripheral IO device 490 in an embodiment may execute machine readable code instructions of the wireless link dynamic environmental congestion detection and remediation agent 451, to monitor data transmissions to the wireless peripheral device dongle 460 across wireless link 424 with expectation of an acknowledgment (ACK) response received at RF front end 496 and radio 495. If the transmission is ignored, for example no ACK response received at radio 495 and RF front end 496, the number of ignored transmissions within a threshold congestion testing time period on the first wireless link is detected by the hardware controller 491 such that the lost packet error rate is determined by a count reaching a threshold of failed ACK responses in an embodiment.

In such a way, a dropped packets error rate over the wireless link 424 operating at the default wireless PHY data and physical radio transfer rate between the wireless peripheral device dongle 460 and the wireless peripheral IO device 490 may be determined by execution of machine readable code instructions of the wireless link dynamic environmental congestion detection and remediation system 450 or agent 451 at either the wireless peripheral device dongle 460 or the wireless peripheral IO device 490. To avoid temporary congestion or data packet loss conditions, a threshold level of dropped packets error rate is determined by execution of machine readable code instructions of the wireless link dynamic environmental congestion detection and remediation system 450 or agent 451 at either the wireless peripheral device dongle 460 or the wireless peripheral IO device 490 respectively in embodiments herein. Upon detection that a number of dropped packets within a preset period of time that meets a threshold congestion value, such as ten percent of packets transmitted within any three second time period being dropped, for example, one or more remediation measures to reduce the wireless link threshold congestion may be triggered in embodiments herein.

In such a case, the hardware microcontroller 461 of the wireless peripheral device dongle 460 or a microcontroller 491 for the wireless peripheral IO device 490 may execute machine readable code instructions 464 or 494, respectively, of the wireless link dynamic environmental congestion detection and remediation system 450 or agent 451 to determine whether the wireless link 424 is currently set to a highest available PHY data and transfer rate supported by the wireless peripheral IO device 490. If the wireless link 424 is currently set to a highest available data and transfer rate supported by the wireless peripheral IO device 490, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to decrease a default or default data and transfer rate to a congestion-avoidance PHY data and transfer rate value for the wireless link 424 undergoing threshold congestion. This reduction to congestion-avoidance PHY data and transfer rate value is shared between the wireless peripheral device dongle 460 and the wireless peripheral IO device 490 sharing wireless link 424. For example, if the wireless link 424 is operating at a BT or BTLE maximum available PHY data and transfer rate of two Mbps, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to decrease the PHY data and transfer rate for the wireless link 424 to a congestion-avoidance PHY data and transfer rate value of one Mbps. This first remediation measure decreases data bits per second at the physical layer of the wireless link and may reduce data resolution somewhat, but the effect of lost data packets on user experience may be also reduced. The reduced data resolution may be less impactful for operation of a wireless peripheral IO device, such as a wireless mouse or wireless keyboard, than the impact of laggy cursor movement or unrecognized clicks or keypresses due to lost data packets in some embodiments.

If the wireless link 424 is not currently set to a highest available data and transfer rate supported by the wireless peripheral IO device 460, this may indicate that some remediation has already been attempted to decrease or avoid detected wireless congestion. In other words, the PHY data and transfer rate for the wireless link 424 undergoing threshold congestion may have already been throttled to the lower congestion-avoidance PHY data and transfer rate value. In such a case, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to decrease a physical radio transfer rate at the link layer of the wireless link 424 to a congestion-avoidance physical radio transfer rate value for the wireless link 424 shared by the wireless peripheral device dongle 460 and the wireless peripheral IO device 490 that undergoing threshold congestion. For example, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to decrease a physical radio transfer rate from a maximum of 125 Hz to a congestion-avoidance physical radio transfer rate value or 105 Hz to reduce the number of data packets or symbols packed onto the PHY data and transfer rate. Although this second remediation measure also may decrease data resolution somewhat, the effect of lost data packets due to threshold congestion on user experience may be also reduced. If the wireless link is not currently set to a highest available data and transfer rate supported by the wireless peripheral IO device, this may indicate that some remediation has already been attempted to decrease or avoid detected wireless congestion.

When one or more remediation steps have been executed to avoid or decrease wireless congestion on the wireless link 424 between the wireless peripheral device dongle and the wireless peripheral IO device 490, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to determine whether the one or more remediation steps previously executed have decreased the wireless congestion on the wireless link 424 between the wireless peripheral device dongle 460 and the wireless peripheral IO device 490 below a congestion threshold level or value of dropped packets or unacknowledged data transmission. This process may be repeated periodically in order to ensure that the wireless link 424 between the wireless peripheral device dongle 460 and the wireless peripheral IO device 490 balances the data and transfer rate and physical radio transfer rate to minimize threshold levels wireless congestion impacting wireless data throughput from the wireless peripheral IO device 490 and maximize user experience.

In order to maximize user experience in such a way, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to return the wireless link 424 to its original highest available data and transfer rate when congestion is not detected. In other words, when threshold congestion is not detected on the wireless link 424 between the wireless peripheral device dongle 460 and the wireless peripheral IO device 490, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, to place the wireless link 424 for the operatively coupled wireless peripheral IO device 490 at a default data and transfer rate supportable by the wireless peripheral IO device 490 and remove any limitations set on the physical radio transfer rate for that wireless link 424 that may have been established during previous remediation steps. In such a way, the hardware microcontroller 461 of the wireless peripheral device dongle 460 or a microcontroller 491 for the wireless peripheral IO device 490 may execute machine readable code instructions 464 or 494, respectively of the wireless link dynamic environmental congestion detection and remediation system 450 or agent 451, respectively, detect threshold congestion and to ensure that the wireless link 424 between the wireless peripheral device dongle 460 and the wireless peripheral IO device 490 dynamically balances the data and transfer rate and physical radio transfer rate to minimize wireless congestion and maximize user experience.

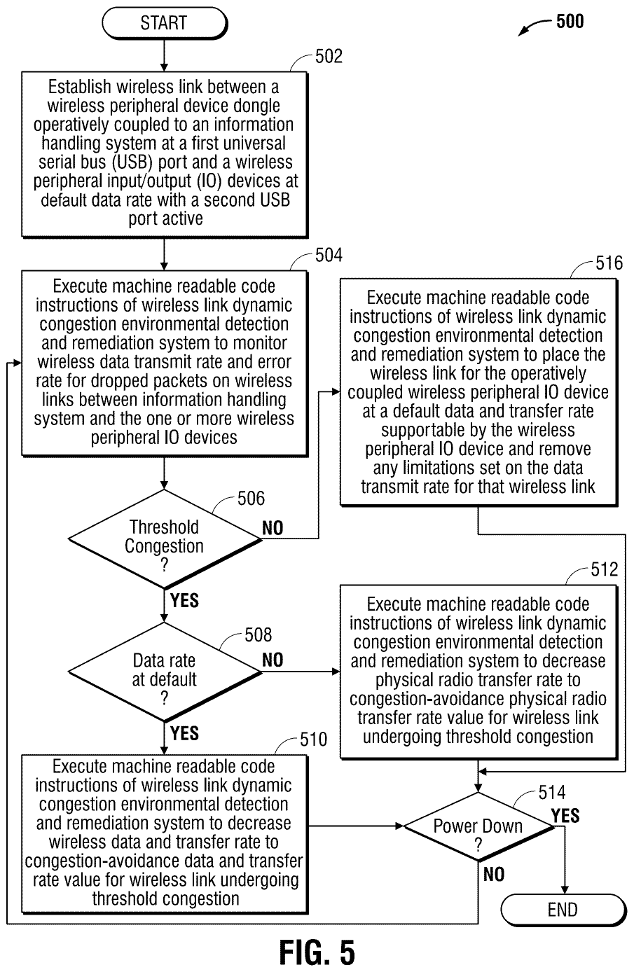

FIG. 5 is a flow diagram illustrating a method of executing machine readable code instructions on a wireless peripheral device dongle or a wireless peripheral input/output (IO) device controller to dynamically detect and remediate congestion on a wireless link operatively coupling the wireless peripheral device dongle with the wireless peripheral IO device according to an embodiment of the present disclosure. As described herein, users of information handling systems often employ multiple wired or wireless input/output devices, each communicating with an information handling system, such as a desktop or laptop computer simultaneously via Universal Serial Bus (USB) ports on the information handling system. In many cases, at least one of these USB ports is operatively coupled to a wireless peripheral device dongle that can communicate wirelessly with a wireless peripheral IO device, such as a mouse, headphones, keyboard, or other wireless IO device. Such USB ports (e.g., USB 2.0 or USB 3.0 standardized ports) are often times located near each other, often on the same exterior wall of the chassis for the information handling system, which can cause interference between these USB ports. This may cause interference, such as cross-talk interference, between the USB ports that can impact any wireless link established between an operatively coupled wireless peripheral device dongle and a wireless peripheral IO device to undergo wireless congestion in which data packets are dropped with a high frequency. This may cause lag or lost data in the form of laggy cursor movement, unrecognized mouse clicks or key presses, or interrupted audio signals, for example.

Congestion on a wireless link caused by close proximity between multiple USB ports of the information handling system operatively coupling with a first wireless peripheral device dongle and either a wired peripheral IO device or a second wireless peripheral device dongle may be avoided or addressed in embodiments herein through a plurality of remediation measures that throttle down the physical layer (PHY) data and transfer rate or throttle down the physical radio transfer rate in the link layer of the established wireless link between the wireless peripheral device dongle and the wireless peripheral IO device. The PHY data and transfer rate in embodiments herein may refer to the maximum data size (e.g., in megabits (Mb)) allowed to transfer within one second through the established wireless link between the wireless peripheral device dongle and the wireless peripheral IO device. The physical radio transfer rate in embodiments herein may refer to the actual electrical physical signal transfer rate of each data packet being transferred per second across the wireless link, such as number or packets or symbols packaged into or with the PHY data and transfer rate being transferred per second, as given in Hertz (Hz).

At block 502, two adjacent universal serial bus (USB) ports are occupied and active with a wireless peripheral device dongle and a second wireless peripheral device dongle or a wired input/output (IO) device respectively at an information handling system. A wireless link may be established in an embodiment between the wireless peripheral device dongle that is operatively coupled to the information handling system in a first USB port and a wireless peripheral input/output (IO) devices at a default data and transfer rate supportable by the wireless peripheral IO device and the wireless peripheral dongle. For example, in the case of a wireless peripheral IO device operating in compliance with the Bluetooth® (BT) or Bluetooth® Low Energy (BTLE) communication protocols, the wireless peripheral IO device and wireless peripheral device dongle may be capable of operating at a default data and transfer rate of two megabits per second (2 Mbps) which then serves as the default data and transfer rate.

A microcontroller for the wireless peripheral device dongle or a hardware controller for the wireless peripheral IO device in an embodiment at block 504 may execute machine readable code instructions of a wireless link dynamic environmental congestion detection and remediation system or agent, respectively, to monitor a wireless physical radio transfer rate and an error rate for dropped packets on the wireless link between the wireless peripheral device dongle and the wireless peripheral IO device. The wireless link dynamic environmental congestion detection and remediation system or an agent thereof may operate in various embodiments herein either on a wireless peripheral device dongle or on the wireless peripheral IO device sharing the wireless link with such a wireless peripheral device dongle to determine data packet loss levels in wireless data transmissions on the wireless link. For example, microcontroller or other hardware controller for the wireless peripheral device dongle, such as a baseband BT microcontroller unit, execute machine readable code instructions of the wireless link dynamic environmental congestion detection and remediation system to detect packet error rate in transmission of wireless data within a threshold congestion testing time period on the first wireless link in an embodiment. In another embodiment, a hardware controller for the wireless peripheral IO device in an embodiment may execute machine readable code instructions of the wireless link dynamic environmental congestion detection and remediation agent, to monitor data transmissions to the wireless peripheral device dongle with expectation of an acknowledgment (ACK) response. If the transmission is ignored, for example no ACK response received, the lost packet error rate is determined by a count reaching a threshold of failed ACK responses within a threshold congestion testing time period on the first wireless link in an embodiment. In such a way, a dropped packets error rate at the default wireless PHY data and physical radio transfer rate on the wireless link between the wireless peripheral device dongle and the wireless peripheral IO device may be determined by execution of machine readable code instructions of the wireless link dynamic environmental congestion detection and remediation system or agent at either the wireless peripheral device dongle or the wireless peripheral IO device. To avoid temporary congestion or data packet loss conditions, a threshold level of dropped packets error rate is determined by execution of machine readable code instructions of the wireless link dynamic environmental congestion detection and remediation system or agent at either the wireless peripheral device dongle or the wireless peripheral IO device respectively.

At block 506, the microcontroller for the wireless peripheral device dongle or the hardware controller for the wireless peripheral IO device in an embodiment may execute machine readable code instructions of the wireless link dynamic environmental congestion detection and remediation system or agent, respectively, to determine whether a threshold level of dropped packets error rate is met indicating that there is threshold congestion on the wireless link between the wireless peripheral device dongle and the wireless peripheral IO device. Upon detection of a number of dropped packets within a preset period of time that meets a threshold congestion value, such as ten percent of packets transmitted within any three second time period being dropped for example, a remediation measure to reduce the wireless link threshold congestion may be triggered. This is just one example of a threshold congestion value, and it is contemplated that any number of dropped packets within any time period determined to negatively impact user experience may form the threshold congestion value. If threshold congestion on the wireless link between the wireless peripheral device dongle and the wireless peripheral IO device is detected, the method may proceed to block 508 for determination of whether the PHY data and transfer rate for the wireless link can be adjusted to remediate the detected threshold congestion. If threshold congestion is not detected on the wireless link between the wireless peripheral device dongle and the wireless peripheral IO device, the method may proceed to block 516 for ensuring that the wireless link between the wireless peripheral device dongle and the wireless peripheral IO device is currently operating at the highest available data and transfer rate supported by the wireless peripheral IO device and there are no current limitations set on the PHY data and transfer rate or the physical radio transfer rate of the link layer for that wireless link.

In an embodiment at block 508, in which threshold congestion on the wireless link between the wireless peripheral device dongle and the wireless peripheral IO device is detected, the microcontroller for the wireless peripheral device dongle or the hardware controller for the wireless peripheral IO device in an embodiment may execute machine readable code instructions of a wireless link dynamic environmental congestion detection and remediation system or agent, respectively, to determine whether the wireless link is currently set to a highest available data and transfer rate supported by the wireless peripheral IO device and wireless peripheral device dongle for the wireless protocol being used. For example, the BT wireless protocol may allow a two Mbps data and transfer rate as a highest available data and transfer rate. If the wireless link is currently set to a highest available data and transfer rate supported by the wireless peripheral IO device and wireless peripheral device dongle, the method may proceed to block 510 to decrease the data and transfer rate for the wireless link between the wireless peripheral device dongle and the wireless peripheral IO device in order to decrease or avoid congestion on the wireless link such that dropped packets have less data loss impact. If the wireless link is not currently set to a highest available data and transfer rate supported by the wireless peripheral IO device, this may indicate that some remediation has already been attempted to decrease or avoid detected wireless congestion, and the method may proceed to block 512 for execution of a second remediation step that includes lowering the physical radio transfer rate for the link layer of the wireless link that may be appropriate to further avoid or decrease wireless congestion on the wireless link.

At block 510, in an embodiment in which the wireless link is currently set to a highest available data and transfer rate supported by the wireless peripheral IO device, the microcontroller for the wireless peripheral device dongle or the hardware controller for the wireless peripheral IO device in an embodiment may execute machine readable code instructions of the wireless link dynamic environmental congestion detection and remediation system or agent, respectively, to decrease a data and transfer rate to a congestion-avoidance PHY data and transfer rate value for the wireless link undergoing threshold congestion. As described herein, congestion on a wireless link caused by close proximity between multiple USB ports of the information handling system operatively coupling with a first wireless peripheral device dongle and either a wired peripheral IO device or a second wireless peripheral device dongle may be avoided or addressed in embodiments herein through a plurality of remediation measures. At block 510, the microcontroller for the wireless peripheral device dongle and the hardware controller for the wireless peripheral IO device in an embodiment may execute machine readable code instructions of the wireless link dynamic environmental congestion detection and remediation system and agent to throttle down the physical layer (PHY) data and transfer rate of the established wireless link between the wireless peripheral device dongle and the wireless peripheral IO device. For example, if the wireless link is operating at a BT or BTLE maximum available data and transfer rate of two Mbps, the microcontroller for the wireless peripheral device dongle and the hardware controller for the wireless peripheral IO device may execute machine readable code instructions of the wireless link dynamic environmental congestion detection and remediation system and agent, respectively, to decrease the data and transfer rate for the wireless link to a congestion-avoidance data and transfer rate value of one Mbps. This first remediation measure decreases data bits per second at the physical layer of the wireless link and may reduce data resolution somewhat, but the effect of lost data packets on user experience may be also reduced. The reduced data resolution may be less impactful for operation of a wireless peripheral IO device, such as a wireless mouse or wireless keyboard, than laggy cursor movement or unrecognized clicks or keypresses due to lost data packets in some embodiments. The method may then proceed to block 514 to determine whether the wireless peripheral IO device or wireless peripheral device dongle have powered down, such that further remediation of later-occurring wireless congestion may not be required.

Returning to block 508, if the physical layer data and transfer rate is not at a maximum data and transfer rate, the method proceeds to block 512. At block 512, in an embodiment in which threshold congestion on the wireless link has been detected and the wireless link is not currently set to a highest available data and transfer rate supported by the wireless peripheral IO device, the microcontroller for the wireless peripheral device dongle or the hardware controller for the wireless peripheral IO device in an embodiment may execute machine readable code instructions of a wireless link dynamic environmental congestion detection and remediation system or agent, respectively, to decrease a physical radio transfer rate at the link layer to a congestion-avoidance physical radio transfer rate value for the wireless link undergoing threshold congestion. This second remediation measure may reduce the actual electrical physical signal transfer rate of each data packet being transferred per second across the wireless link, such as reducing the number of packets or symbols packaged onto the PHY data and transfer rate on the wireless link for example. While this second remediation measure also may decrease data resolution somewhat, the effect of lost data packets on user experience may be also reduced. If the wireless link is not currently set to a highest available data and transfer rate supported by the wireless peripheral IO device, this may indicate that some remediation has already been attempted to decrease or avoid detected wireless congestion. In other words, the data and transfer rate for the wireless link undergoing threshold congestion may have already been throttled to the lower congestion-avoidance data and transfer rate value.

In an example embodiment, the microcontroller for the wireless peripheral device dongle and the hardware controller for the wireless peripheral IO device may execute machine readable code instructions of the wireless link dynamic environmental congestion detection and remediation system and agent, respectively, to decrease a physical radio transfer rate to a congestion-avoidance a physical radio transfer rate value for the wireless link undergoing threshold congestion at block 512. For example, the microcontroller for the wireless peripheral device dongle or the hardware controller for the wireless peripheral IO device may execute machine readable code instructions of the wireless link dynamic environmental congestion detection and remediation system and agent, respectively, to decrease a physical radio transfer rate from a maximum of 125 Hz to a congestion-avoidance physical radio transfer rate value or 105 Hz to reduce the number of data packets or symbols packed onto the PHY data and transfer rate, which may have been lowered to one Mbps in the example embodiment. The method may then proceed to block 514 to determine whether the wireless peripheral IO device or wireless peripheral device dongle have powered down, such that further remediation of later-occurring wireless congestion may not be required.

In an embodiment at block 514 in which one or more remediation steps have been executed at blocks 510 or 512, respectively, to avoid or decrease wireless congestion on the wireless link between the wireless peripheral device dongle and the wireless peripheral IO device, it may be determined whether the wireless peripheral device dongle or the wireless peripheral IO device have been powered down. If both the wireless peripheral device dongle and the wireless peripheral IO device are still powered on and the wireless link between them remains active, the method may proceed back to block 504 to determine whether the one or more remediation steps executed at block 510 or 512 has decreased the wireless congestion on the wireless link between the wireless peripheral device dongle and the wireless peripheral IO device. If either the wireless peripheral device dongle or the wireless peripheral IO device have been powered down, the wireless link between them may have been severed, and there may be no further need to detect wireless congestion on that wireless link. In such a case, the method to dynamically detect and remediate congestion on a wireless link operatively coupling the wireless peripheral device dongle with the wireless peripheral IO device may then end.

Returning to block 516, in an embodiment in which threshold congestion is not detected on the wireless link between the wireless peripheral device dongle and the wireless peripheral IO device, the microcontroller for the wireless peripheral device dongle or the hardware controller for the wireless peripheral IO device may execute machine readable code instructions of a wireless link dynamic environmental congestion detection and remediation system or agent, respectively, to place the wireless link for the operatively coupled wireless peripheral IO device at a default data and transfer rate supportable by the wireless peripheral IO device and remove any limitations set on the physical radio transfer rate for that wireless link. Threshold congestion may be absent after one or more remediation steps have been executed to decrease the congestion on the wireless link, or when a secondary USB port is not causing any interference with the USB port to which the wireless peripheral device dongle is operatively coupled. For example, a device operatively coupled to the secondary USB port may be inactive or may have been removed. In either scenario, user experience is likely to improve if the wireless link between the wireless peripheral device dongle and the wireless peripheral IO device is then dynamically set back to maximum allowable data and transfer rate and data symbol transfer rate. The method may then proceed back to block 514 to determine whether the wireless peripheral IO device or wireless peripheral device dongle have powered down, such that further remediation of later-occurring wireless congestion may not be required.

In other words, when threshold congestion is not detected on the wireless link between the wireless peripheral device dongle and the wireless peripheral IO device, the microcontroller for the wireless peripheral device dongle or the hardware controller for the wireless peripheral IO device may execute machine readable code instructions of the wireless link dynamic environmental congestion detection and remediation system or agent, respectively, to place the wireless link for the operatively coupled wireless peripheral IO device at a default data and transfer rate supportable by the wireless peripheral IO device and remove any limitations on the physical radio transfer rate for that wireless link that may have been established during previous remediation steps. In such a way, the microcontroller for the wireless peripheral device dongle or the hardware controller for the wireless peripheral IO device may execute machine readable code instructions of a wireless link dynamic environmental congestion detection and remediation system or agent, respectively, to detect threshold congestion and ensure that the wireless link between the wireless peripheral device dongle and the wireless peripheral IO device dynamically balances the PHY data and transfer rate and a physical radio transfer rate to minimize wireless congestion and maximize user experience.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A first wireless peripheral device dongle executing machine readable code instructions of a wireless link dynamic environmental congestion detection and remediation system comprising:
the first wireless peripheral device dongle operatively coupled to an information handling system via a first universal serial bus (USB) port;
a first wireless peripheral device dongle radio to establish a first wireless link between the first wireless peripheral device dongle and a first wireless peripheral input/output (IO) device at highest available wireless data and transfer rate with the first wireless peripheral IO device;
a hardware microcontroller to execute machine readable code instructions of the wireless link dynamic environmental congestion detection and remediation system to determine, a first number of data packets meeting a threshold congestion value have been dropped within a threshold congestion testing time period on the first wireless link due via detection of a packet error rate the first wireless peripheral device dongle radio due to interference between the first USB port and a second USB port; and
the hardware controller to execute machine readable code instructions of the wireless link dynamic environmental congestion detection and remediation system to decrease a physical layer data and transfer rate for the first wireless link to a congestion-avoidance physical layer data and transfer rate value for decreasing wireless transmission congestion.

2. The wireless peripheral device dongle of claim 1, wherein the first wireless link is established in accordance with the Bluetooth® (BT) communications protocol.

3. The wireless peripheral device dongle of claim 1, wherein the first wireless link is established in accordance with the Bluetooth® Low Energy (BTLE) communications protocol.

4. The wireless peripheral device dongle of claim 1, wherein the first wireless peripheral IO device highest available physical layer data and transfer rate is two megabits per second (Mbps).

5. The wireless peripheral device dongle of claim 1, wherein the congestion-avoidance physical layer data and transfer rate value is one megabit per second (Mbps).

6. The wireless peripheral device dongle of claim 1 further comprising:
the hardware microcontroller to determine, after decreasing the physical layer data and transfer rate for the first wireless link to the congestion-avoidance physical layer data and transfer rate value, a second number of data packets dropped meets the threshold congestion value within the threshold congestion testing time period on the first wireless link; and
the hardware controller to reduce a physical radio transfer rate for the first wireless link to a congestion-avoidance physical radio transfer rate value for further decreasing wireless transmission congestion.

7. The wireless peripheral device dongle of claim 1 further comprising:
the hardware controller to execute machine readable code instructions to determine, after decreasing the physical layer data and transfer rate for the first wireless link to the congestion-avoidance physical layer data and transfer rate value, a second number of data packets dropped falls below the threshold congestion value within the threshold congestion testing time period on the first wireless link; and
the hardware controller to return the physical layer data and transfer rate for the first wireless link to the highest available physical layer data and transfer rate.

8. A method of executing machine readable code instructions of wireless link dynamic environmental congestion detection and remediation agent comprising:
establishing a first wireless link for a wireless peripheral input/output (IO) device, via a wireless peripheral IO device radio, with a wireless peripheral device dongle operatively coupled to an information handling system, at a first universal serial bus (USB) port, where the wireless link operates highest available physical layer data and transfer rate as a default physical layer data and transfer rate;
executing machine readable code instructions of a wireless link dynamic environmental congestion detection and remediation agent, via a hardware controller at wireless peripheral IO device, to determine a first number of data packets are lost meeting a threshold congestion value within a threshold congestion testing time period on the first wireless link due to interference between the first wireless link and a second USB port operatively coupling a USB device to the information handling system; and
decreasing a physical layer data and transfer rate for the first wireless link, via the hardware controller, to a congestion-avoidance physical layer data and transfer rate value for decreasing wireless transmission congestion.

9. The method of claim 8, wherein the first wireless link is established in accordance with the Bluetooth® (BT) communications protocol.

10. The method of claim 8, wherein the first wireless link is established in accordance with the Bluetooth® Low Energy (BTLE) communications protocol.

11. The method of claim 8, wherein the first wireless peripheral IO device highest available physical layer data and transfer rate is two megabits per second (Mbps).

12. The method of claim 8, wherein the congestion-avoidance physical layer data and transfer rate value is one megabit per second (Mbps).

13. The method of claim 8 further comprising:
determining after decreasing the physical layer data and transfer rate for the first wireless link to the congestion-avoidance physical layer data and transfer rate value, via the hardware controller, a second number of data packets dropped meeting the threshold congestion value within the threshold congestion testing time period on the first wireless link; and
reducing a physical radio transfer rate for the first wireless link, via the hardware controller, to a congestion-avoidance physical radio transfer rate value for further decreasing wireless transmission congestion.

14. The method of claim 8 further comprising:
determining after decreasing the physical layer data and transfer rate for the first wireless link to the congestion-avoidance physical layer data and transfer rate value, via the hardware microcontroller, a second number of data packets dropped falls below the threshold congestion value within the threshold congestion testing time period on the first wireless link; and
increasing the physical layer data and transfer rate for the first wireless link, via the hardware controller, to the highest available physical layer data and transfer rate.

15. A wireless peripheral device dongle executing a wireless link dynamic environmental congestion detection and remediation system comprising:
the first wireless peripheral device dongle operatively coupled to an information handling system via a first universal serial bus (USB) port;
a first wireless peripheral device dongle radio to establish a first wireless link between the first wireless peripheral device dongle and a first wireless peripheral input/output (IO) device at highest available wireless data and transfer rate with the first wireless peripheral IO device;
a hardware controller to execute machine readable code instructions of the wireless link dynamic environmental congestion detection and remediation system to determine a first number of data packets dropped meeting a threshold congestion value within a threshold congestion testing time period on the first wireless link due to interference between the first wireless link via the first USB port and a second USB port operatively coupling a USB device to the information handling system;
the hardware controller to decrease a physical layer data and transfer rate for the first wireless link to a congestion-avoidance physical layer data and transfer rate value for decreasing wireless transmission congestion;
the hardware controller to determine, after decreasing the physical layer data and transfer rate for the first wireless link to the congestion-avoidance physical layer data and transfer rate value, that a second number of data packets are dropped meeting the threshold congestion value within the threshold congestion testing time period on the first wireless link; and
the hardware controller to reduce a physical radio transfer rate for the first wireless link to a congestion-avoidance physical radio transfer rate value for further decreasing wireless transmission congestion.

16. The wireless peripheral device dongle of claim 15 further comprising:
the hardware controller to reduce the physical radio transfer rate for the first wireless link to the congestion-avoidance physical radio transfer rate value that is 20 Hz lower for data symbols packed onto the physical layer data and transfer rate than the physical radio transfer rate for the first wireless link before reduction.

17. The wireless peripheral device dongle of claim 15, wherein the congestion-avoidance physical layer data and transfer rate value is one megabit per second (Mbps).

18. The wireless peripheral device dongle of claim 15, wherein the wireless peripheral IO device highest available physical layer data and transfer rate is two megabits per second (Mbps).

19. The wireless peripheral device dongle of claim 15 further comprising:
the hardware controller to execute machine readable code instructions of the wireless link dynamic environmental congestion detection and remediation system to determine, after reducing the physical radio transfer rate for the first wireless link to the congestion-avoidance physical radio transfer rate value, a third number of data packets dropped falls below the threshold congestion value within the threshold congestion testing time period on the first wireless link; and
the hardware controller to execute machine readable code instructions of the wireless link dynamic environmental congestion detection and remediation system to increase the physical layer data and transfer rate for the first wireless link to the highest physical layer data and transfer rate supportable by the wireless peripheral device dongle.

20. The wireless peripheral device dongle of claim 15 further comprising:
the hardware controller to execute machine readable code instructions of the wireless link dynamic environmental congestion detection and remediation system to determine, after reducing the physical radio transfer rate for the first wireless link to the congestion-avoidance physical radio transfer rate value, a third number of data packets dropped falls below the threshold congestion value within the threshold congestion testing time period on the first wireless link; and
the hardware controller to execute machine readable code instructions of the wireless link dynamic environmental congestion detection and remediation system to increase the physical radio transfer rate and the physical layer data and transfer rate for the first wireless link to the wireless peripheral IO device highest physical layer data and transfer rate and the previous physical radio transfer rate for the wireless peripheral IO device.
